(19) United States
(12) Patent Application Publication
(10) Pub. No.: US 2007/0155944 A1
(43) Pub. Date: Jul. 5, 2007

(54) Fiberglass binder comprising cured benzohydro-benzofurane

(76) Inventors: Kiarash Alavi Shooshtari, Littleton, CO (US); Jawed Asrar, Greenwood Village, CO (US)

Correspondence Address: JOHNS MANVILLE, 10100 WEST UTE AVENUE, LITTLETON, CO, 80127, US

(21) Appl. No.: 11/322,985

(22) Filed: Dec. 30, 2005

(51) Int. Cl. C08G 14/02

(52) U.S. Cl. 528/129

(57) ABSTRACT

A curable formaldehyde-free binding composition for use with fiberglass is provided. Such curable composition comprises a reaction product of a multi-aldehyde or multi-ketone and a phenolic compound. When heated, the reaction product undergoes curing to form a water-insoluble cured benzohydro-benzofurane binder which exhibits good adhesion to glass. In a preferred embodiment, a reaction product of a multi-aldehyde and a phenolic compound having more than one phenolic group initially is formed. The fiberglass can be provided in various configurations when bound by the binding composition of the present invention, and preferably is in the form of a non-woven. In a particularly preferred embodiment, the final product is a mat or building insulation.

### BACKGROUND OF THE INVENTION

1. Field of the Invention

The subject invention pertains to an improved binding composition for use with fiberglass. More specifically, the invention pertains to an improved curable composition comprising a reaction product of a multi-aldehyde or multi-ketone and a phenolic compound. When heated, the reaction product when present as a coating on glass fibers undergoes curing to form a water-insoluble cured benzohydro-benzofurane binder which exhibits good adhesion to glass. The cured binder of the present invention is useful as a fully acceptable replacement for formaldehyde-based binders in non-woven fiberglass products.

2. Description of the Related Art

Fiberglass binders have a variety of uses ranging from stiffening applications where the binder is applied to woven or non-woven fiberglass sheet goods and cured, producing a stiffer product; thermo-forming applications wherein the binder resin is applied to a sheet or lofty fibrous product, following which it is dried and optionally B-staged to form an intermediate but yet curable product; and to fully cured systems such as building insulation.

Fibrous glass insulation products generally comprise matted glass fibers bonded together by a cured thermoset polymeric material. Molten streams of glass are drawn into fibers of random lengths and blown into a forming chamber where they are randomly deposited as a mat onto a traveling conveyor. The fibers, while in transit in the forming chamber and while still hot from the drawing operation, are sprayed with an aqueous binder. A phenol-formaldehyde binder has been used throughout the fibrous glass insulation industry. The residual heat from the glass fibers and the flow of air through the fibrous mat during the forming operation are generally sufficient to volatilize water from the binder, thereby leaving the remaining components of the binder on the fibers as a viscous or semi-viscous high solids liquid. The coated fibrous mat is transferred to a curing oven where heated air, for example, is blown through the mat to cure the binder and rigidly bond the glass fibers together.

Fiberglass binders used in the present sense should not be confused with matrix resins which are an entirely different and non-analogous field of art. While sometimes termed “binders”, matrix resins act to fill the entire interstitial space between fibers, resulting in a dense, fiber reinforced product where the matrix must translate the fiber strength properties to the composite, whereas “binder resins” as used herein are not space-filling, but rather coat only the fibers, and particularly the junctions of fibers. Fiberglass binders also cannot be equated with paper or wood product “binders” where the adhesive properties are tailored to the chemical nature of the cellulosic substrates. Many such resins are not suitable for use as fiberglass binders. One skilled in the art of fiberglass binders would not look to cellulosic binders to solve any of the known problems associated with fiberglass binders.

Binders useful in fiberglass insulation products generally require a low viscosity in the uncured state, yet possess characteristics so as to form a rigid thermoset polymeric mat for the glass fibers when cured. A low binder viscosity in the uncured state is required to allow the mat to be sized correctly. Also, viscous binders commonly tend to be tacky or sticky and hence they lead to the accumulation of fiber on the forming chamber walls. This accumulated fiber may later fall onto the mat causing dense areas and product problems. A binder which forms a rigid matrix when cured is required so that a finished fiberglass thermal insulation product, when compressed for packaging and shipping, will recover to its as-made vertical dimension when installed in a building.

From among the many thermosetting polymers, numerous candidates for suitable thermosetting fiberglass binder resins exist. However, binder-coated fiberglass products are often of the commodity type, and thus cost becomes a driving factor, generally ruling out resins such as thermosetting polyurethanes, epoxies, and others. Due to their excellent cost/performance ratio, the resins of choice in the past have been phenol-formaldehyde resins. Phenol-formaldehyde resins can be economically produced, and can be extended with urea prior to use as a binder in many applications. Such urea-extended phenol-formaldehyde binders have been the mainstay of the fiberglass insulation industry for years, for example.

Over the past several decades however, minimization of volatile organic compound emissions (VOCs) both on the part of the industry desiring to provide a cleaner environment, as well as by Federal regulation, has led to extensive investigations into not only reducing emissions from the current formaldehyde-based binders, but also into candidate replacement binders. For example, subtle changes in the ratios of phenol to formaldehyde in the preparation of the basic phenol-formaldehyde resole resins, changes in catalysts, and addition of different and multiple formaldehyde scavengers, has resulted in considerable improvement in emissions from phenol-formaldehyde binders as compared with the binders previously used. However, with increasingly stringent Federal regulations, more and more attention has been paid to alternative binder systems which are free from formaldehyde.

One such candidate binder system employs polymers of acrylic acid as a first component, and a polyol such as glycerine or a modestly oxyalkylated glycerine as a curing or “crosslinking” component. The preparation and properties of such poly(acrylic acid)-based binders, including information relative to the VOC emissions, and a comparison of binder properties versus urea-formaldehyde binders is presented in “Formaldehyde-Free Crosslinking Binders For Non-Wovens”, Charles T. Arkins et al., TAPPI JOURNAL, Vol. 78, No. 11, pages 161-168, November 1995. The binders disclosed by the Arkins article, appear to be B-stageable as well as being able to provide physical properties similar to those of urea/formaldehyde resins.

U.S. Pat. No. 5,340,868 discloses fiberglass insulation products cured with a combination of a polycarboxy polymer, a-hydroxyalkylamide, and at least one trifunctional monomeric carboxylic acid such as citric acid. The specific polycarboxy polymers disclosed are poly(acrylic acid) polymers. See also, U.S. Pat. No. 5,143,582.

U.S. Pat. No. 5,318,990 discloses a fibrous glass binder which comprises a polycarboxy polymer, a monomeric trihydric alcohol and a catalyst comprising an alkali metal salt of a phosphorous-containing organic acid.

Published European Patent Application EP 0 583 086 A1 appears to provide details of polyacrylic acid binders whose cure is catalyzed by a phosphorus-containing catalyst system as discussed in the Arkins article previously cited. Higher molecular weight poly (acrylic acids) are stated to provide polymers exhibiting more complete cure. See also U.S. Pat. Nos. 5,661,213; 5,427,587; 6,136,916; and 6,221,973.

Some polycarboxy polymers have been found useful for making fiberglass insulation products. Problems of clumping or sticking of the glass fibers to the inside of the forming chambers during the processing, as well as providing a final product that exhibits the recovery and rigidity necessary to provide a commercially acceptable fiberglass insulation product, have been overcome. See, for example, U.S. Pat. No. 6,331,350. The thermosetting acrylic resins have been found to be more hydrophilic than the traditional phenolic binders, however. This hydrophilicity can result in fiberglass insulation that is more prone to absorb liquid water, thereby possibly compromising the integrity of the product. Also, the thermosetting acrylic resins now being used as binding agents for fiberglass have been found to not react as effectively with silane coupling agents of the type traditionally used by the industry. The addition of silicone as a hydrophobing agent results in problems when abatement devices are used that are based on incineration. Also, the presence of silicone in the manufacturing process can interfere with the adhesion of certain facing substrates to the finished fiberglass material. Overcoming these problems will help to better utilize polycarboxy polymers in fiberglass binders.

Accordingly, it is an objective of the present invention to provide a novel, non-phenol-formaldehyde binder.

It is an object of the invention to provide a novel fiberglass binder which provides advantageous flow properties, the possibility of lower binder usage, the possibility of overall lower energy consumption, elimination of interference by a silane, and improved overall economics.

It is another object of the present invention to provide fiberglass products including non-wovens which are bound by the fiberglass binder of the present invention.

It is a further object of the invention to provide a process for applying an improved water-insoluble binder to fiberglass.

These and other objects of the present invention will become apparent to the skilled artisan upon a review of the following description and the claims appended hereto.

### SUMMARY OF THE INVENTION

A curable composition for use in the binding of fiberglass is provided comprising a reaction product of a multi-aldehyde or multi-ketone and a phenolic compound which upon heating is capable of forming a water-insoluble cured benzohydro-benzofurane binder which exhibits good adhesion to glass.

A process for binding fiberglass is contemplated comprising providing on the fiberglass a coating of a composition comprising the curable reaction product of a multi-aldehyde or multi-ketone and a phenolic compound and thereafter curing the reaction product while present as a coating on said fiberglass to form a water-insoluble cured benzohydro-benzofurane binder which exhibits good adhesion to glass.

Fiberglass products which are bound through the use of the binding composition of the present invention additionally are provided.

### DETAILED DESCRIPTION OF PREFERRED EMBODIMENTS

The novel fiberglass binder composition is a curable composition comprising the reaction product of a multi-aldehyde or multi-ketone and a phenolic compound. When coated on fiberglass and heated this reaction product undergoes curing to form a water-insoluble cured benzohydro-benzofurane binder which adheres well to glass.

The multi-aldehyde and multi-ketone each contain two or more aldehyde or ketone groups respectively. The selection of the specific multi-aldehyde or multi-ketone, and phenolic compound commonly is influenced by cost considerations.

In a preferred embodiment of the present invention, a multi-aldehyde is reacted with a phenolic compound. Representative multi-aldehydes include glyoxal, glutaraldehyde, 1,6-hexanedial, 1,4-terephthalic dialdehyde, polyarolein, etc., and mixtures of these. A multi-aldehydes is preferred over a multi-ketone since the formation of the reaction product commonly tends to proceed on a more expeditious basis.

In the other embodiment of the present invention, a multi-ketone is reacted with a phenolic compound. Representative multi-ketones include butanedione, 2,3-pentanedione, 2,4-pentanedione, cyclohexanedione, etc., and mixtures of these.

The phenolic compound which is reacted with the multi-aldehyde or multi-ketone may be phenol. Alternatively, in a preferred embodiment of the present invention the phenolic compound contains more than one phenolic group (i.e., two or more phenolic groups). Representative phenolic compounds for use in the present invention having more than one phenolic group include hydroquinone, catechol, resorcinol, 1,6-dihydroxy naphthalene, 2,6-dihydroxy naphthalene, bisphenol A, etc., and mixtures of these.

When forming the reaction product, the molar ratio of the multi-aldehyde or multi-ketone to the phenolic compound commonly is approximately 1:1 to 3:1.

The reaction product preferably is formed in an aqueous medium while the reactants are heated with stirring. Representative reaction temperatures commonly range from approximately 50 to 80° C. (e.g., approximately 70° C.). The pH of the aqueous medium can be acidic or basic and commonly is adjusted to approximately 3.5 to 8. A mineral acid, such as sulfuric acid, can be used to provide an acidic pH, and compounds such as sodium bicarbonate, sodium bisulfite, ammonium bisulfite, etc., conveniently can be utilized to provide a basic pH. It has been found that the formation of the reaction product proceeds more expeditiously at a basic pH (e.g., at a pH of approximately 8).

When the multi-aldehyde or multi-ketone are heated in an aqueous medium with stirring at a temperature of approximately 50 to 80° C., reaction times of approximately 3 to 12 hours commonly are sufficient. Shorter reaction times within this range commonly can be utilized when a multi-aldehyde is reacted with the phenolic compound. For instance, a reaction time of 4 hours commonly is adequate when utilizing a multi-aldehyde at a basic pH. Since the formation of the reaction product commonly proceeds more slowly when a multi-ketone is reacted with the phenolic compound, longer reaction times commonly are employed with this reactant. However, no adverse consequences are encountered when heating the reactants at 50 to 80° C. for 12 hours or longer.

The reaction product while present in the medium in which it was formed is a flowable and curable composition.

The composition when applied to the fiberglass optionally can include adhesion prompters, oxygen scavengers, solvents, emulsifiers, pigments, fillers, anti-migration aids, coalescents, welting agents, biocides, plasticizers, organosilanes, anti-foaming agents, colorants, waxes, suspending agents, anti-oxidants, crosslinking catalysts, secondary crosslinkers, and combinations of these.

The coating application can be achieved in accordance with known techniques for coating a fibrous web. In preferred embodiments, these include spraying, spin-curtain coating, dipping-roll coating, etc. The composition can be applied to freshly-formed fiberglass, or to fiberglass following collection.

The fiberglass can be provided in various configurations when bound by the binding composition of the present invention, and preferably is in the form of a non-woven. In preferred embodiments, the non-woven fiberglass is in the form of fibrous mats or particularly building insulation. In other embodiments, the fiberglass is a microglass-based substrate useful when forming a printed circuit board, battery separator, filter stock, or reinforcement scrim.

Once applied to the fiberglass, the coated reaction product is heated at a temperature and time sufficient to achieve curing to form a water-insoluble cured benzohydro-benzofurane binder which exhibits good adhesion to glass. During the curing, crosslinking also takes place. Representative curing temperatures commonly are approximately 100 to 250° C., (e.g., 120 to 160° C.) for approximately 5 to 40 minutes (e.g., approximately 10 to 30 minutes). The curing reaction tends to be expedited if the pH of the composition that is coated on the fiberglass is acidic (e.g., approximately 3 to 6, and most preferably approximately 4). For instance, the pH can be adjusted by adding an appropriate concentration of a mineral acid, such as sulfuric acid, prior to applying the coating to the fiberglass.

The cured benzohydro-benzofurane at the conclusion of the curing step commonly is present as a secure coating on the fiberglass in a concentration of approximately 0.5 to 50 percent by weight of the fiberglass, and most preferably in a concentration of approximately 1 to 10 (e.g., 5 to 6) percent by weight of the fiberglass.

The present invention provides a formaldehyde-free route to form a securely bound formaldehyde-free fiberglass product. The binder composition of the present invention makes possible ease of coating application, the elimination of interference by a silane, and improved overall economics.

The following examples are presented to provide specific examples of the present invention. In each instance, the thin glass plate substrate that receives the coating can be replaced by fiberglass. It should be understood, however, that the invention is not limited to the specific details set forth in the Examples.

### EXAMPLE 1

To 11 grams of hydroquinone in 50 grams of water at a pH of 8.0 were added dropwise 14.5 grams of a 40 percent aqueous solution glyoxal. The pH was adjusted by the use of sodium bicarbonate and the molar ratio of glyoxal to hydroquinone was approximately 1:1. A flowable intermediate reaction product was formed while the reactants were stirred at 70° C. over a 12 hour period. This liquid next was coated on a thin glass plate and was heated at 140° C. for approximately 20 minutes. During such heating at 140° C. curing took place to form a cured benzohydro-benzofurane amber coating that was water insoluble and displayed excellent adhesions to glass.

### EXAMPLE 2

Example 1 was substantially repeated with the exception that 11 grams of catechol were substituted for the hydroquinone. The molar ratio of glyoxal to catechol was approximately 1:1. Similar results were achieved.

### EXAMPLE 3

Example 1 was substantially repeated with the exception that 11 grams of resorcinol were substituted for the hydroquinone. The molar ratio of glyoxal to resorcinol was approximately 1:1. Similar results were achieved.

### EXAMPLE 4

Example 1 was substantially repeated with the exception that 9.4 grams of phenol were substituted for the hydroquinone and 25 grams of a 40 percent aqueous solution of glyoxal were utilized. The molar ratio of glyoxal to phenol was approximately 2:1. The resulting cured benzo-hydrobenzofurane coating was water-insoluble and displayed excellent adhesion to glass but was somewhat less robust than that formed in Examples 1 to 3 where a multi-phenolic reactant was employed.

### EXAMPLE 5

Example 1 was substantially repeated with the exception that 9.4 grams of phenol were substituted for the hydroquinone. The quantity of glyoxal was unchanged and the molar ratio of glyoxal to phenol was approximately 1:1. The resulting cured benzohydro-benzofurane coating included less cross-linking when compared to that formed in Example 4 where a greater molar concentration of glyoxal was utilized and was less stable at elevated use temperatures.

### EXAMPLE 6

To 11 grams of hydroquinone in 50 grams of water at a pH of 8.0 were added dropwise 29.0 grams of a 40 percent aqueous solution of glyoxal. The pH was adjusted by use sodium bicarbonate and the molar ratio of glyoxal to hydroquinone was approximately 2:1. A flowable intermediate reaction product was formed while the reactants stirred at 70° C. over a 12 hour period. The liquid next was coated on a thin glass plate and was heated at 140° C. for approximately 20 minutes. During such heating at 140° C. curing took place to form a cured benzohydro-benzofurane amber coating that was water insoluble and displayed excellent adhesion to glass. The resulting cured benzohydro-benzofurane product was more highly cross-linked and less linear than that formed in Example 1 in view of the greater molar concentration of the glyoxal reactant.

### EXAMPLE 7

Example 6 was substantially repeated with the pH being adjusted to 4.0 by the presence of sulfuric acid. Substantially similar results were achieved.

### EXAMPLE 8

To 11 grams of catechol in 50 grams of water at a pH of 8.0 were added dropwise 29.0 grams of a 40 percent aqueous solution of glyoxal. The pH was adjusted by use of sodium bicarbonate and the molar ratio of glyoxal to catechol was approximately 2:1. A flowable intermediate reaction product was formed while the reactants stirred at 70° C. over a 12 hour period. The liquid next was coated on a thin glass plate and was heated at 140° C. for approximately 20 minutes. During such heating at 140° C. curing took place to form a cured benzohydro-benzofurane amber coating that was water insoluble and displayed excellent adhesion to glass. The resulting cured benzohydro-benzofurane product was more highly cross-linked and less linear than that formed in Example 2 in view of the greater molar concentration of the glyoxal reactant.

### EXAMPLE 9

Example 8 was substantially repeated with the pH being adjusted to 4.0 by the presence of sulfuric acid. Substantially similar results were achieved.

### EXAMPLE 10

To 11 grams of resorcinol in 50 grams of water at a pH of 8.0 were added dropwise 29.0 grams of a 40 percent aqueous solution of glyoxal. The pH was adjusted by use of sodium bicarbonate and the molar ratio of glyoxal to resorcinol was approximately 2:1. A flowable intermediate reaction product was formed while the reactants stirred at 70° C. over a 12 hour period. The liquid next was coated on a thin glass plate and was heated at 140° C. for approximately 20 minutes. During such heating at 140° C. curing took place to form a cured benzohydro-benzofurane amber coating that was water insoluble and displayed excellent adhesion to glass. The resulting cured benzohydro-benzofurane product was more highly cross-linked and less linear than that formed in Example 3 in view of the greater molar concentration of the glyoxal reactant.

### EXAMPLE 11

Example 10 was substantially repeated with the pH being adjusted to 4.0 by the presence of sulfuric acid. Substantially similar results were achieved.

### EXAMPLE 12

To 16 grams of 1,6-dihydroxy naphthalene in 50 grams of water at a pH of 4.0 were added dropwise 29.0 grams of a 40 percent aqueous solution of glyoxal. The pH was adjusted by the use of sulfuric acid and the molar ratio of glyoxal to 1,6-dihydroxy naphthalene was approximately 1:1. A flowable intermediate reaction product was formed while the reactants were stirred at 70° C. over a 12 hour period. This liquid was next coated on a thin glass plate and was heated at 140° C. for approximately 20 minutes. During such heating at 140° C. curing took place to form a cured benzohydro-benzofurane water-insoluble coating that displayed excellent adhesion to glass.

### EXAMPLE 13

To 11 grams of hydroquinone in 50 grams of water at a pH of 4.0 were added dropwise 20 grams of acetylacetone. The pH was adjusted by the use of sulfuric acid and the molar ratio of acetylacetone to hydroquinone was approximately 1:1. A flowable intermediate reaction product was formed while the reactants were stirred at 70° C. over a 12 hour period. This liquid was next coated on a thin glass plate and was heated at 140° C. for approximately 30 minutes. During heating at 140° C. curing took place to form a soft cured benzohydro-benzofurane water-insoluble coating that displayed excellent adhesion to glass.

### EXAMPLE 14

Example 13 was substantially repeated with the exception that 17.2 grams of diacetyl were substituted for the acetylacetone. The molar ratio of diacetyl to hydroquinone was approximately 1:1. Similar results were achieved.

The principles, preferred embodiments, and modes of operation of the present invention have been described in the foregoing specification. The invention which is protected herein, however, is not to be construed as being limited to the particular forms disclosed, since these are to be regarded as being illustrative rather than restrictive. Variations and changes may be made by those skilled in the art without departing from the spirit of the invention.

We claim:

1. A curable composition for use in the binding of fiberglass comprising a reaction product of a multi-aldehyde or multi-ketone and a phenolic compound which upon heating is capable of forming a water-insoluble cured benzohydro-benzofurane binder which exhibits good adhesion to glass.

2. A curable composition for use in the binding of fiberglass according to claim 1 wherein said reaction product is formed by the reaction of a multi-aldehyde and phenolic compound.

3. A curable composition for use in the binding of fiberglass according to claim 1 wherein a multi-aldehyde is reacted with said phenolic compound and said multi-aldehyde is selected from the group consisting of glyoxal, glutaraldehyde, 1,6-hexanedial, 1,4-terephthalic dialdehyde, polyacrolein, and mixtures of the foregoing.

4. A curable composition for use in the binding of fiberglass according to claim 1 wherein a multi-ketone is reacted with said phenolic compound and said multi-ketone is selected form the group consisting of butanedione, 2,3-pentanedione, 2,4-pentanedione, cyclohexanedione, and mixtures of the foregoing.

5. A curable composition for use in the binding of fiberglass according to claim 1 wherein said phenolic compound is phenol.

6. A curable composition for use in the binding of fiberglass according to claim 1 wherein said phenolic compound has more than one phenolic group.

7. A curable composition for use in the binding of fiberglass according to claim 1 wherein said reaction product is formed by the reaction of a multi-aldehyde and a phenolic compound having more than one phenolic group.

8. A curable composition for use in the binding of fiberglass according to claim 1 wherein said phenolic compound is selected from the group consisting of hydroquinone, catechol, resorcinol, 1,6-dihydroxy naphthalene, 2,6-dihydroxy naphthalene, bisphenol A, and mixtures of the foregoing.

9. A curable composition for use in the binding of fiberglass wherein the molar ratio of said multi-aldehyde or multi-ketone to said phenolic compound when forming said reaction product is approximately 1:1 to 3:1.

10. A curable composition for use in the binding of fiberglass according to claim 9 wherein said reaction product is formed in an aqueous medium at a pH of approximately 3.5 to 8 while heating at approximately 50 to 80° C.

11. A curable composition for use in the binding of fiberglass according to claim 10 wherein said reaction product was formed while heating over a period of 4 to 12 hours.

12. A process for binding fiberglass comprising providing on said fiberglass a coating of a composition comprising the curable reaction product of multi-aldehyde or multi-ketone and a phenolic compound and thereafter curing said reaction product while present as a coating on said fiberglass to form a water-insoluble cured benzohydro-benzofurane binder which exhibits good adhesion to glass.

13. A process for binding fiberglass according to claim 12 wherein said reaction product is formed by the reaction of a multi-aldehyde and a phenolic compound.

14. A process for binding fiberglass according to claim 12 wherein a multi-aldehyde is reacted with said phenolic compound and said multi-aldehyde is selected from the group consisting of glyoxal, glutaraldehyde, 1,6-hexanedial, 1,4-terephthalic dialdehyde, polyacrolein, and mixtures of the foregoing.

15. A process for binding fiberglass according to claim 12 where a multi-ketone is reacted with said phenolic compound and said multi-ketone is selected from the group consisting of butanedione, 2,3-pentanedione, 2.4-pentanedione, cyclohexanedione, and mixtures of the foregoing.

16. A process for binding fiberglass according to claim 12 wherein said phenolic compound is phenol.

17. A process for binding fiberglass according to claim 12 wherein said phenolic compound has more than one phenolic group.

18. A process for binding fiberglass according to claim 12 wherein said reaction product is formed by the reaction of a multi-aldehyde and a phenolic compound having more than one phenic group.

19. A process for the binding of fiberglass according to claim 12 wherein said phenolic compound is selected from the group consisting of hydroquinone, catechol, resorcinol, 1,6-dihydroxy naphthalene, 2,6-dihydroxy naphthalene, bisphenol A, and mixtures of the foregoing.

20. A process for the binding of fiberglass according to claim 19 wherein said reaction product is formed in an aqueous medium at a pH of approximately 3.5 to 8 while heating at approximately 50 to 80° C.

21. A process for the bonding of fiberglass according to claim 20 wherein said reaction product is formed while heating over a period of 3 to 12 hours.

22. A process for the bonding of fiberglass according to claim 20 wherein said curing is carried out at a temperature of approximately 100 to 250° C. for approximately 5 to 40 minutes.

23. A process for the bonding of fiberglass according to claim 20 wherein said curing is carried out at temperature of approximately 120 to 160° C. for approximately 10 to 30 minutes.

24. A fiberglass non-woven product formed by the process of claim 12.

25. A fiberglass non-woven product according to claim 24 wherein the product is building insulation.

26. A fiberglass non-woven product according to claim 24 wherein the product is a fibrous mat.

27. A fiberglass product formed by the process of claim 12, wherein the product is a microglass-based substrate useful for any of a printed circuit board, battery separator, filter stock, or reinforcement scrim.
